(19) United States
(12) Patent Application Publication
(10) Pub. No.: US 2010/0231014 A1
(43) Pub. Date: Sep. 16, 2010

(54) Child Car Seat with Vibration

(76) Inventors: Steve Gibree, Woonsocket, RI (US); Lois DiMartinis, Woonsocket, RI (US)

Correspondence Address: IP STRATEGIES, 12 1/2 WALL STREET, SUITE E, ASHEVILLE, NC, 28801, US

(21) Appl. No.: 12/425,723

(22) Filed: Apr. 17, 2009

Related U.S. Application Data
(60) Provisional application No. 61/045,795, filed on Apr. 17, 2008.

(51) Int. Cl. B60N 2/44

(52) U.S. Cl. 297/217.1

(57) ABSTRACT

A child car seat includes a seat assembly that is adapted to support a child in a vehicle, and a vibration mechanism that is adapted to provide a vibrating motion to a child supported by the seat assembly.

### CROSS-REFERENCE TO RELATED APPLICATION

This is related to and claims priority from U.S. Provisional Patent Application Ser. No. 61/045,795, which was filed on Apr. 17, 2008 and which is incorporated herein in its entirety.

### FIELD OF THE INVENTION

The invention relates to child car seats, used to secure a child in a vehicle of any type.

### BACKGROUND OF THE INVENTION

Car seat for infants are mandatory in the United States, and help prevent a baby from being injured during a traffic accident or under even normal driving conditions, providing support from the jostling that can take place during car travel.

Movement in a car can also be beneficial to an infant passenger. Often, the vibration experienced by a baby riding in a car will be soothing, quieting a cranky baby and even causing the baby to fall asleep. However, once the car is stopped and the engine is turned off, the beneficial effects of the car vibration also end abruptly, often resulting in crankiness from the previously contented or sleeping infant. It would be advantageous to provide a car seat that would continue to apply the soothing vibration to the infant even after the car has stopped and has been turned off.

### BRIEF SUMMARY OF THE INVENTION

According to an aspect of the invention, a child car seat includes a seat assembly that is adapted to support a child in a vehicle, and a vibration mechanism that is adapted to provide a vibrating motion to a child supported by the seat assembly. The seat assembly, for example, can include a seat element that is adapted to support a child, and a base element that is adapted to be coupled to the vehicle and to couple with the seat element.

For example, the vibration mechanism can be attached to the seat element. The seat element can include at least a partial fabric cover, and the vibration mechanism can be attached to the fabric cover. For example, the vibration mechanism can be sewn into the fabric cover. The vibration mechanism can be a soft and pliable device, such as one that conforms to a contour of the seat element.

The seat assembly can include a frame, and the vibration mechanism can be attached to the frame. According to a particular embodiment, the frame can include a plurality of component members, and the vibration mechanism can be adapted to cause at least two of the component members to move with respect to each other.

The vibration mechanism can be attached to the base element.

The child car seat can also include controls for the vibration mechanism, and the controls can be located remotely from the vibration mechanism. For example, the seat assembly can include a frame, and the controls can be attached to the frame. According to certain embodiments, the frame can include a handle, and the controls can be disposed on the handle. Alternatively, the controls can be disposed in a wireless remote unit, such as a wireless remote unit that is adapted to attach to a vehicle component. For example, the wireless remote unit and the vehicle component can include respective mating hook-and-loop fastening elements.

The vibration mechanism can be adjusted to provide a variable amount of vibrational motion and/or a variable frequency of vibrational motion. For example, the vibration mechanism can be adapted to oscillate at a frequency that is within the range of a normal human heart rate. The frequency can be adjustable to a selected frequency within the range, or can be adjustable to one of a number of pre-set frequencies within the range.

The vibration mechanism can be adapted to provide a periodic reciprocating motion to the seat assembly. An amplitude of the reciprocating motion is adjustable, and a damping rate of the reciprocating motion can be adjustable.

The vibration mechanism can be adapted to provide a rocking motion to the seat element with respect to the base element.

### BRIEF DESCRIPTION OF THE DRAWINGS

FIG. 1 shows an exemplary embodiment of the child car seat of the present invention.

FIG. 2 shows an exemplary wireless remote unit of the present invention.

### DETAILED DESCRIPTION OF THE INVENTION

The present invention is a car seat for infants that includes a vibration mechanism for providing a vibrating motion to the infant supported by the car seat. When the car motion stops, the vibrating sensation continues to soothe the infant. This vibrating motion can be similar to that used in child bouncers. The vibrating motion can be provided by a mechanism included in or attached to the car seat. For example, the fabric of the car seat can have a vibrating mechanism sewn in, or the vibrating mechanism can be attached to the frame of the car seat to provide the vibrating motion. As another example, different components of the car seat, such as different solid pieces forming the seat, can be made to move with respect to each other, resulting in a vibrating or rocking motion experienced by the infant held by the support. Many car seats attach to a base portion that is removably fixed to the adult seat of the car. It is contemplated that the vibrational element can be attached to or made part of the base portion, allowing the vibration to be imparted to the infant from the base portion through the attached seat portion.

Preferably, the vibrational element can be adjusted to provide a variable amount of vibrational motion and/or to provide a variable frequency of vibrational motion. The vibrational element can be powered by a typical disposable battery, or by a rechargeable battery or fuel cell, or can be coupled to the electrical system of the car.

The vibrational element can be fabricated integrally with the car seat, such that it is permanently attached to the car seat or is constructed as part of the car seat or one of the car seat components. For example, the vibrational element can form part of the frame, handle, seat, or other component of the car seat. Alternatively, the invention can be embodied solely as the vibrational element, which is adapted to be attached to a conventional car seat. The vibrational element can have a fixed shape and size, such as would be the case if it is fabricated in a hard enclosure, with attachment means for attaching to a component of the car seat. Alternatively, the vibrational element can be a soft or pliable device that can be wrapped around a component of the car seat or that can be adapted, for example, to the contour of the car seat. Further, the vibrational element can be encased in a soft lining, for example, to be used as the inner lining of the car seat, so as to provide a soft vibrational surface for the seated child.

The controls for the vibrational element, such as the on/off control and controls for any of the vibrational parameters, can be located directly on the working component of the vibrational element, or can be located remotely from the working component. For example, if the vibration element lines the car seat, the controller for the vibration element can be attached to the handle, frame, or edge of the car seat, for easy access and manipulation by another passenger in the car. The controller component can be connected to the working component by a cable, which can be used to provide control signals from the controller component to the working component. Alternatively, the controller component can provide a wireless signal to the working component, such as by a signal on a radio frequency or infrared carrier. In this case, the driver can have remote control of the vibrational unit, so that the unit can be turned on and off and adjusted without the need to divert attention from driving. The controller component preferably includes a fastener or other attachment component so that the controller component can be removably attached, for example, to the steering wheel or other location convenient to the driver. The fastener can be, for example, a hook and loop fastener strip.

An infant finds great comfort in the heartbeat of his mother. An infant can become accustomed to the regular frequency of his mother's heartbeat, which by itself can calm the child when he becomes cranky. Thus, the present invention provides a particular advantage by having the pre-set vibration frequency set to the same frequency as a normal resting adult heartbeat. For example, the vibration mechanism can be set to vibrate the seat at a frequency of sixty-six oscillations per minute. Particular embodiments of the present invention having tunable vibration frequencies can be set to a vibration frequency that more closely matches the heart rate of the infant's primary care provider (mother, father, nanny, etc.), or that can simply be tuned while determining the infant's response to the varying frequency. Alternatively, several pre-set frequencies can be selected, and one can be chosen for the particular situation, or the particular infant placed in the support, such as in a day care setting.

The vibration mechanism itself is also conventional, in which a periodic reciprocating motion is applied to the frame or other component of the seat to effectuate the vibration. The amplitude of the applied motion, and the spring quality and damping of the seat frame can all be adjusted to result in the precise nature of vibration suitable for soothing the infant.

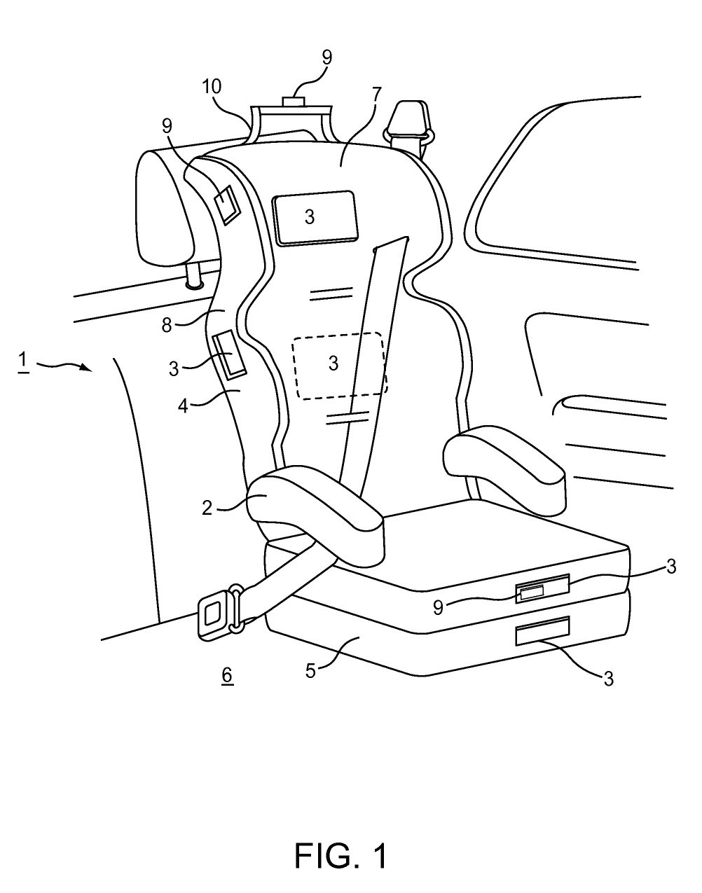

As shown in FIG. 1, a child car seat 1 includes a seat assembly 2 that is adapted to support a child in a vehicle, and a vibration mechanism 3 that is adapted to provide a vibrating motion to a child supported by the seat assembly 2. The vibration mechanism 3 is shown in various locations in this drawing figure. These locations are illustrative of the various locations that the vibration mechanism 3 can be placed according to the present invention. It is contemplated that, within the scope of the invention, the vibration mechanism 3 can be placed in any one location or multiple locations as shown herein, in any combination, or in like locations according to the written description herein provided. Further, although the child car seat shown in the drawing figure is of the type that faces forward in a vehicle and is suitable for use with a toddler who is sitting upright, the child car seat of the invention is intended to encompass all types of child car seats, including forward- and rearward-facing cradle-type seats for infants.

In this exemplary embodiment, the seat assembly 2 includes a seat element 4 that is adapted to support a child, and a base element 5 that is adapted to be coupled to the vehicle, such as to a vehicle seat 6, and to couple with the seat element 4. In such embodiments, the base element 5 usually remains attached to a vehicle seat 6, whereas the seat element 4 is removably coupled to the base element 5 only when in use in the vehicle. Some seat assemblies 2 feature a seat element 4 and frame that attach directly to the vehicle seat 6 for each use, without coupling to a stationary base element 5. It is contemplated that the present invention can be embodied as such child car seats as well, and a base element 5 is not a necessary component of the inventive child car seat 1.

The vibration mechanism 3 can be disposed anywhere that would allow the vibrating or reciprocating motion provided by the vibration mechanism 3 to be imparted to a child supported by the seat element 4. For example, the vibration mechanism 3 can be attached to any portion of the seat element 4 that would allow the vibration mechanism 3 to provide the vibrating motion to the child in the seat element 4. For example, the seat element 4 can include at least a partial, preferably padded, fabric cover 7, and the vibration mechanism 3 can be attached to the fabric cover 7. The vibration mechanism 3 can be attached either to the outside of the fabric cover 7, or it can be sewn into the fabric cover 7. If the vibration mechanism 7 is embodied as a soft and pliable device, it can conform to a contour of the seat element 4, whether it is attached directly to the seat element 4 or to or within the fabric cover 7.

As shown in this embodiment, the seat element 4 includes a frame 8. The vibration mechanism 3 can be attached to the frame 8, in order to provide the vibrational motion to a child supported by the seat element 4. The frame 8 can be a unitary structure, or can be assembled from a plurality of component members. In the latter case, the vibration mechanism 3 can be adapted to cause at least two of the component members to move with respect to each other in order to provide the vibrational motion.

Alternatively, the vibration mechanism 3 can be attached to the base element 5, in order to impart the vibrational motion to a child supported by the seat element 4 through the seat element 4. The vibration mechanism 3 can be located on the base element 5 at a location at which the base element 5 is in direct contact with the seat element 4, or in any other strategic location calculated to appropriately pass the vibrational motion through the structure of the child car seat 1.

Control of the vibration mechanism 3 can be automatic. For example, the vibration mechanism 3 can be actuated automatically when the seat element 4 is coupled to the base element 5, with the vibrational motion starting immediately on actuation, or after a specified time delay. Preferably, the child car seat includes a control unit 9 for the vibration mechanism 3, by which a user can turn the vibration mechanism 3 on and off, and control other functions and parameters. The control unit 9 is shown in various locations in this drawing figure. These locations are illustrative of the various locations that the control unit 9 can be placed according to the present invention. It is contemplated that, within the scope of the invention, the control unit 9 can be placed in any one location or multiple locations as shown herein, in any combination, or in like locations according to the written description herein provided.

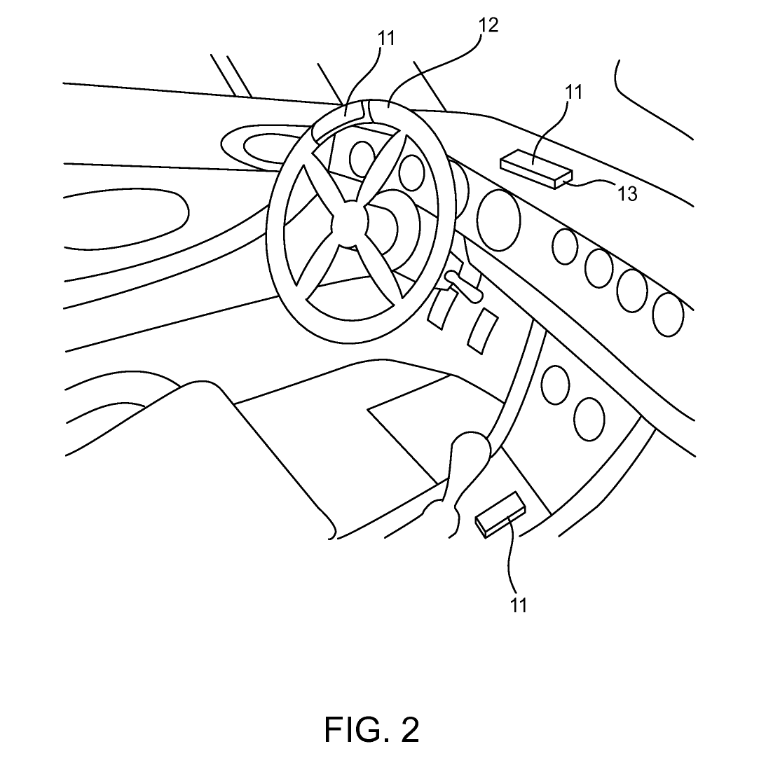

The control unit 9 can be located on the vibration mechanism 3 or can be a part of the vibration mechanism 3. Alternatively, the control unit can be located remotely from the vibration mechanism 3. For example, the control unit 9 can be disposed on the frame 8 of the seat element 4. According to certain embodiments, the frame 8 can include a handle 10, and the control unit 9 can be disposed on the handle 10. Alternatively, the control unit 9 can be a wireless remote unit 11, which can be adapted to be attached to a vehicle component 12, as shown in FIG. 2. For example, the wireless remote unit 11 can be adapted to be attached to the steering wheel of the vehicle, or to the dash board or center console unit, for convenient use by the driver of the vehicle. The wireless remote unit 11 can include a fastener to facilitate attachment to the vehicle component 12. For example, the wireless remote unit 11 and the vehicle component 12 can include respective mating hook-and-loop fastening elements 13.

Preferably, the control unit 9 can be used to adjust certain parameters of the vibrational motion provided by the vibration unit 3. For example, the vibration mechanism 3 preferably can be adjusted to provide a variable amplitude of vibrational motion and/or a variable frequency of vibrational motion. For example, the vibration mechanism 3 preferably can be adjusted by the user to oscillate at a frequency that is within the range of a normal human heart rate. For example, the frequency can be adjustable to a selected particular frequency within the range, or the vibration mechanism 3 can have pre-sets for a number of particular frequencies within the range, and one of the pre-set frequencies can be selected by the user.

The nature of the vibrational motion provided by the vibration mechanism 3 is not limited within the scope of the invention. For example, a periodic reciprocating motion can be provided to the seat element 4 by, for example, a vibration mechanism 3 that pushes against the stationary base element 5 to move the seat element 4, in embodiments wherein the seat element 4 has a certain degree of freedom of motion. Preferably, the amplitude and/or damping rate of the reciprocating motion is adjustable. The reciprocating motion can be provided as a rocking motion to the seat element 4 with respect to the base element 5.

Preferred and alternative embodiments have been described in detail above. These embodiments are not intended to be limiting of the invention, but rather merely illustrate the inventive concept. The invention is recited in the following claims, which should be given the broadest scope of interpretation in view of the description and reasonable equivalents.

We claim:

1. A child car seat, comprising:
a seat assembly that is adapted to support a child in a vehicle; and
a vibration mechanism that is adapted to provide a vibrating motion to a child supported by the seat assembly.

2. The child car seat of claim 1, wherein the seat assembly includes
a seat element that is adapted to support a child; and
a base element that is adapted to be coupled to the vehicle and to couple with the seat element.

3. The child car seat of claim 2, wherein the vibration mechanism is attached to the seat element.

4. The child car seat of claim 3, wherein the seat element includes at least a partial fabric cover, and the vibration mechanism is attached to the fabric cover.

5. The child car seat of claim 4, wherein the vibration mechanism is sewn into the fabric cover.

6. The child car seat of claim 5, wherein the vibration mechanism is a soft and pliable device.

7. The child car seat of claim 6, wherein the vibration mechanism conforms to a contour of the seat element.

8. The child car seat of claim 3, wherein the seat element includes a frame, and the vibration mechanism is attached to the frame.

9. The child car seat of claim 8, wherein the frame includes a plurality of component members, and the vibration mechanism is adapted to cause at least two of the component members to move with respect to each other.

10. The child car seat of claim 2, wherein the vibration mechanism is attached to the base element.

11. The child car seat of claim 1, further comprising controls for the vibration mechanism, wherein the controls are located remotely from the vibration mechanism.

12. The child car seat of claim 11, wherein the seat assembly includes a frame, and wherein the controls are attached to the frame.

13. The child car seat of claim 12, wherein the frame includes a handle, and the controls are disposed on the handle.

14. The child car seat of claim 11, wherein the controls are disposed in a wireless remote unit.

15. The child car seat of claim 14, wherein the wireless remote unit is adapted to attach to a vehicle component.

16. The child car seat of claim 15, wherein the wireless remote unit includes and the vehicle component include respective mating hook-and-loop fastening elements.

17. The child car seat of claim 1, wherein the vibration mechanism can be adjusted to provide at least one of a variable amount of vibrational motion and a variable frequency of vibrational motion.

18. The child car seat of claim 17, wherein the vibration mechanism is adapted to oscillate at a frequency that is within the range of a normal human heart rate.

19. The child car seat of claim 18, wherein the frequency is adjustable to a selected frequency within the range.

20. The child car seat of claim 18, wherein the frequency is adjustable to pre-set frequencies within the range.

21. The child car seat of claim 1, wherein the vibration mechanism is adapted to provide a periodic reciprocating motion to the seat assembly.

22. The child car seat of claim 21, wherein an amplitude of the reciprocating motion is adjustable.

23. The child car seat of claim 21, wherein a damping rate of the reciprocating motion is adjustable.

24. The child car seat of claim 2, wherein the vibration mechanism is adapted to provide a rocking motion to the seat element with respect to the base element.
